(19) United States
(12) Patent Application Publication
(10) Pub. No.: US 2016/0210237 A1
(43) Pub. Date: Jul. 21, 2016

(54) STORAGE DEVICE, DATA ACCESS METHOD, AND PROGRAM RECORDING MEDIUM

(71) Applicant: NEC CORPORATION, Tokyo (JP)

(72) Inventor: Dai KOBAYASHI, Tokyo (JP)

(73) Assignee: NEC CORPORATION, Tokyo (JP)

(21) Appl. No.: 14/908,161

(22) PCT Filed: Jul. 15, 2014
(86) PCT No.: PCT/JP2014/003733

§ 371 Date: Jan. 28, 2016

(30) Foreign Application Priority Data
Jul. 30, 2013 (JP) 2013-157346

(51) Int. Cl. G06F 12/08

(52) U.S. Cl. CPC G06F 12/0877; G06F 2212/60

(57) ABSTRACT

Disclosed is a storage device which provides data with higher data throughput performance during in-memory storage access in an access environment with little locality. This storage device is equipped with: a data storage means, which includes a main memory that stores data in a block unit, and a cache memory capable of storing, in the block unit, the data stored in the main memory; access request accumulation means for accumulating an access request for data stored in the data storage means; data scanning means for, when the access request accumulated in the access request accumulation means satisfy a prescribed condition, reads the data stored in the main memory, in the block units and writes the data in the cache memory in order, and scans the data; and access retrieval means for reading from the access request accumulation means an access request for data specified by means of the scan, and returns information with which the specified data can be specified to the source from which that access request was transmitted.

### TECHNICAL FIELD

The present invention relates to a distributed data storage delivery system, a storage device, a data distribution method, a divided data management device, a host terminal, and a program for data distribution. In particular, the present invention relates to a technique for distributing and storing data generated from a plurality of geographically-separated information sources in a plurality of storage devices.

### BACKGROUND ART

A system in which data momentarily generated from a plurality of geographically-separated terminals, such as a sensor and a user terminal, is collected, the data is transferred to a datacenter through a wide area network, such as the Internet, the data is stored in a group of computers in the datacenter, and the stored data is processed is known.

As information from a sensor, numerical data, such as positional information using a GPS (Global Positioning System), temperature information by a thermometer, an acceleration rate and a rate by an acceleration sensor, and power consumption by a smart meter and the like, are conceivable. Also, complex binary data, such as speech information acquired by a microphone, a still image acquired by a camera, and a moving image stream and the like, are conceivable.

In addition, as information from a user terminal, information, such as posting on a microblog service and a log of telephone call information, is conceivable.

Along with the popularization of cloud computing that processes data using a computer resource connected through the Internet, the above-described data has been aggregated in a geographically-separated datacenter through the Internet, a public wireless network, and the like. In order to transmit the collected data (hereinafter, referred to as “collected data”) to a system of the datacenter, the data needs to be transmitted to a gateway server (or application server) provided at the entrance of the system of the datacenter. Hereinafter, the gateway server (or application server) provided at the entrance of the datacenter is referred to as “storage client”.

The collected data that has reached a network in the datacenter is received by the storage client, processed and stored in a storage system to be perpetuated. Then, the collected data is taken for use in analysis or the like. Here, “perpetuation of data” means that data is held so that the data exists without being deleted. As an example of the perpetuation, a replica or a code that only satisfies redundancy defined in the system is stored in a non-volatile storage medium.

The storage system is a system that holds data and provides the holding data. Specifically, the storage system provides basic functions (accesses), such as CREATE (INSERT), READ, WRITE (UPDATE), and DELETE, for a part of the data. In addition, the storage system sometimes provides a wide variety of functions, such as authority management and data structuring reduction.

A distributed storage system has a number of computers connected through a communication network and an interconnect, and composes a storage system using storage devices included in these computers.

In the distributed storage system, data is distributed and stored in a plurality of storage nodes. Thus, when accessing the data, the storage client needs to know which storage node holds the data. In addition, when there are a plurality of storage nodes that hold the data to be accessed, the storage client needs to know which storage node to access.

Data to be stored is accessed in a certain meaningful unit. For example, in a relational database, data is written in units called record or tuple. In addition, in a file system, data is written as a set of blocks. Furthermore, in a key-value store, data is written as an object. The data written in this manner is read by a user computer in each unit. Hereinafter, the data unit is referred to as “data object”.

As a storage device, a hard disk drive (HDD) or a magnetic tape has been usually used. In recent years, in addition to the HDD, a solid state drive (SSD) using a non-volatile semiconductor memory, such as a flash memory, capable of reading/writing faster is used in many cases. In addition, the distributed storage system can also use a volatile storage device by holding a replica in the plurality of storage nodes.

For example, an example using “in-memory storage” which uses a DRAM (Dynamic Random Access Memory) used as a main storage device of a computer and can read/write faster than the SSD is increased. In particular, when storing and using the above-described information from a sensor, the size of each data object is small, such as tens of bytes to hundreds of bytes, and thus, access in 4 Kbytes units that has been usually used in the HDD is inefficient. Thus, use of the in-memory storage is suitable.

In the case of the in-memory storage, for storing, acquiring, scanning, and specifying data, a CPU (Central Processing Unit) of a storage node browses and processes data in a main memory of the storage node.

The access rate to the DRAM is generally hundreds of times lower than the operation clock of the CPU. Thus, the CPU has a cache memory configured by a SRAM (Static Random Access Memory) by which faster and low latency (more specifically, time from when data transfer or the like is required till when the result is returned is short) access is possible.

In addition, a computer of recent years has a multicore configuration equipped with a plurality of CPUs in many cases. In this case, the cache memory with relatively-long access latency has a multistep configuration and is shared by a plurality cores is used. Alternatively, a cache with short latency that is held in each core and is consistently managed between the cores, and a primary cache that operates at a rate substantially equal to the CPUs, or the like is also used.

Furthermore, some CPU has a function called a MMU (Memory Management Unit) so as to use the main storage efficiently. Access from programs that operate in the computer uses a series of memory address space (virtual memory space) closed in each program (or process).

Access to the main storage in each process is specified by an address of the virtual memory space (logical address), and the logical address is translated into an address of a physical memory unit (physical address) by a logical-physical address translation function (logical-physical translation). The logical-physical address translation function is implemented in OS (Operating System) software, but, has a problem in that operation is slow in the case of being achieved by only the software. Thus, the MMU performs a part of the logical-physical address translation. The MMU is equipped with a small-capacity cache memory called a TLB (Translation Look-aside Buffer), and commonly-used data for logical-physical translation is recorded in the TLB, so that the logical-physical translation can be performed fast.

In recent years, the amount of data that can be stored in the main memory as the in-memory storage, i.e. the amount of memory equipped in each computer has been increased. The CPU has been increased in speed more than the DRAM. Therefore, it is known that an increase in access time (penalty) due to a cache miss and a TLB miss when using the main memory as the in-memory storage becomes a performance problem. Here, the cache miss means DRAM access when necessary data does not exist in the cache memory. In addition, the TLB miss means DRAM access when logical-physical translation information for necessary data access does not exist in the TLB in the MMU.

For example, in NPL 2, an index structure of a memory in consideration of the penalty of the cache miss and the TLB miss is proposed.

In addition, an occurrence of a context switch in the process thread is another performance problem in the in-memory storage. The computer of recent years has a multicore configuration equipped with a plurality of CPUs, and preferably, the process is divided into a plurality of process units called threads so as to utilize process by the cores.

A context switch in core does not occur when the number of the threads is equal to that of the cores. However, the number of the threads is generally much more than the number of cores. This is due to facilitation of a program (simplification of design), concealment of a core idle resource in a cache miss, recycling of the same software in a wide variety of pieces of hardware, and the like.

Consequently, a context switch in which a plurality of threads in one core operate while alternating register sets to be used occurs. An influence of the context switch on the performance is not small. For example, in NPL 1, a technique regarding assignment of threads for OLTP (On-Line Transaction Processing) in view of the influence of the context switch is disclosed.

When stream data is assumed to be a list in which objects are arranged in chronological order, one object includes a unique primary key and one or two or more properties (metadata1, metadata2, . . . ). For example, stream data including values of two properties (name1, name2) in addition to the primary key has a configuration {key: hogehoge, name1: value1, name2: value2}.

Data newly-acquired by a sensor is stored as the mass of data as described above. When using the data, one or more objects can be specified by specifying a key value or by specifying one or more values or ranges of the properties.

In order to increase the speed of operation for specifying data to be used, a technique for making an index structure or an index in stored data is known. As the index structure, a tree structure called B+-Tree capable of retrieving and specifying a range fast is known. Alternatively, as described in NPL 3, in an in-memory storage, a structure, such as T-Tree, which is more suitable for memory access is also known.

### CITATION LIST

### Patent Literature

[NPL 1] Robert Kallman, Hideaki Kimura, Jonathan Natkins, Andrew Pavlo, Alexander Rasin, Stanley Zdonik, Evan P. C. Jones, Samuel Madden, Michael Stonebraker, Yang Zhang, John Hugg, and Daniel J. Abadi, “H-store: a high-performance, distributed main memory transaction processing system”, Proc. VLDB Endow. vol. 1, 2, August 2008, pp. 1496-1499.

[NPL 2] Changkyu Kim, Jatin Chhugani, Nadathur Satish, Eric Sedlar, Anthony D. Nguyen, Tim Kaldewey, Victor W. Lee, Scott A. Brandt, and Pradeep Dubey, “FAST: fast architecture sensitive tree search on modern CPUs and GPUs”, Proceedings of the 2010 ACM SIGMOD International Conference on Management of data (SIGMOD '10), ACM, New York, pp. 339-350.

[NPL 3] T. J. Lehman, “A Study of Index Structures for Main Memory Database Management Systems”, Proceedings of the Twelfth International Conference on Very Large Data Bases, 1986, pp. 294-303.

### SUMMARY OF INVENTION

### Technical Problem

It is assumed that stream data is stored in a distributed storage that stores data in in-memory storage. When there is difference in occurrence frequency of stream data or request frequency for use the data with respect to each sensor, data usage locality occurs, and thus speeding up of the cache memory contributes. On the other hand, usage in system used in recent years in which the access request for data usage (hereinafter, referred to as “data usage access”) with small bias (with small locality) occurs with respect to a stream with small occurrence frequency bias has been considered. For the example of such system, the system in which all of video data acquired by a monitoring video or the like is stored as stream data and all of the data is used for face image recognition is conceivable.

In such system, in the case where accessing the stream data by the access for data use using an index structure, all of the stored data is accessed evenly, and thus, a cache miss and a TLB miss occur with high frequency. The cache miss and the TLB miss decrease access performance of the in-memory storage.

In particular, in recent years, a usage environment in which a large amount of data usage accesses each of which specifies data generated in the latest several seconds occur is conceivable. For example, when one hundred million data usage accesses are generated per second with respect to one million objects generated in the latest one second, the influence of the access performance decrease due to the above-described cache miss and the TLB miss becomes large.

In addition, in a distributed storage system, data is distributed and stored in accordance with a certain condition. For example, a technique for deciding a storing node in accordance with a range of a primary key value or a hash value is used. In this case, in order to specify data other than the primary key, desired data may be stored in all nodes, and thus, data usage accesses need to be issued for the all nodes. Therefore, the number of data usage accesses to the respective storage nodes is drastically increased, and thus, the influence of the access performance decrease due to the cache miss becomes large in the same manner as the above.

On the other hand, data usage in which a large amount of data usage accesses occur as above has a feature that longer access delay time is also permitted unlike a distributed storage system used in a financial institution or a company. Delay time of a public wireless line is long, such as tens milliseconds, and thus, even when a distributed storage system that communicates through such a public wireless circuit does not always provide data in a microsecond order, the influence on the performance is small. In the above-described data usage environment, throughput performance indicating how many accesses can be handled per second is more emphasized than response.

In this manner, provision of data with higher throughput performance is desired during in-memory storage access in an access environment with small locality. However, such a technique is not disclosed in the above-described NPL 1 to 3.

The invention of the present application has been made in view of the above-described problem, and a main object thereof is to provide a storage device, a data access method, and a program recording medium which can provide data with higher throughput performance during in-memory storage access in an access environment with small locality.

### Solution to Problem

A storage device of one aspect of the present invention includes:

data storage means for having a main memory that stores data in a block unit, and a cache memory capable of storing the data stored in the main memory in the block unit;

access request accumulation means for accumulating an access request for data stored in the data storage means;

data scanning means for, when the access request accumulated in the access request accumulation means satisfy a prescribed condition, reading the data stored in the main memory included in the data storage means in order in the block unit, and writing the data in the cache memory and scans the data; and

access retrieval means for reading from the access request accumulation means an access request for data specified by the scan, and replies information with which the specified data can be specified to a source from with the access request was transmitted.

A data access method of one aspect of the present invention includes:

accumulating an access request for data stored in a data storage means which includes a main memory that stores data in a block unit, and a cache memory capable of storing the data stored in the main memory in the block unit, in an access request accumulation means;

when the access request accumulated in the access request accumulation means satisfy a prescribed condition, reading the data stored in the main memory included in the data storage means in order in the block unit, and writing the data in the cache memory and scanning the data by a data scanning means; and

by an access retrieval means, reading from the access request accumulation means an access request for data specified by the scanning, and replying information with which the specified data can be specified to a source from with the access request was transmitted.

In addition, the object is also achieved by a computer program that achieves the storage device or the data access method having each of the above-described configurations with a computer, and a computer-readable recording medium that stores the computer program.

### ADVANTAGEOUS EFFECTS OF INVENTION

According to the invention of the present application, during in-memory storage access in an access environment with small locality, an effect that data can be provided with higher throughput performance can be obtained.

### BRIEF DESCRIPTION OF DRAWINGS

FIG. 1 is a block diagram illustrating a configuration of a distributed storage system according to a first exemplary embodiment of the present invention.

FIG. 2 is a block diagram illustrating a configuration of a storage node according to the first exemplary embodiment of the present invention.

FIG. 3 is a flow chart describing an operation of the storage node according to the first exemplary embodiment of the present invention.

FIG. 4 is a diagram illustrating a data storage example of a data storage unit according to the first exemplary embodiment of the present invention.

FIG. 5 is a block diagram illustrating a configuration of a storage node according to a second exemplary embodiment of the present invention.

FIG. 6 is a block diagram illustrating a configuration of a storage node according to a third exemplary embodiment of the present invention.

FIG. 7 is a block diagram illustrating a configuration of a storage node according to a fourth exemplary embodiment of the present invention.

FIG. 8 is a block diagram illustrating a configuration of a storage node according to a fifth exemplary embodiment of the present invention.

FIG. 9 is a diagram illustrating a hardware configuration of the storage node according to the first exemplary embodiment of the present invention.

### DESCRIPTION OF EMBODIMENTS

Hereinafter, exemplary embodiments of the present invention will be described in detail with reference to the drawings.

### First Exemplary Embodiment

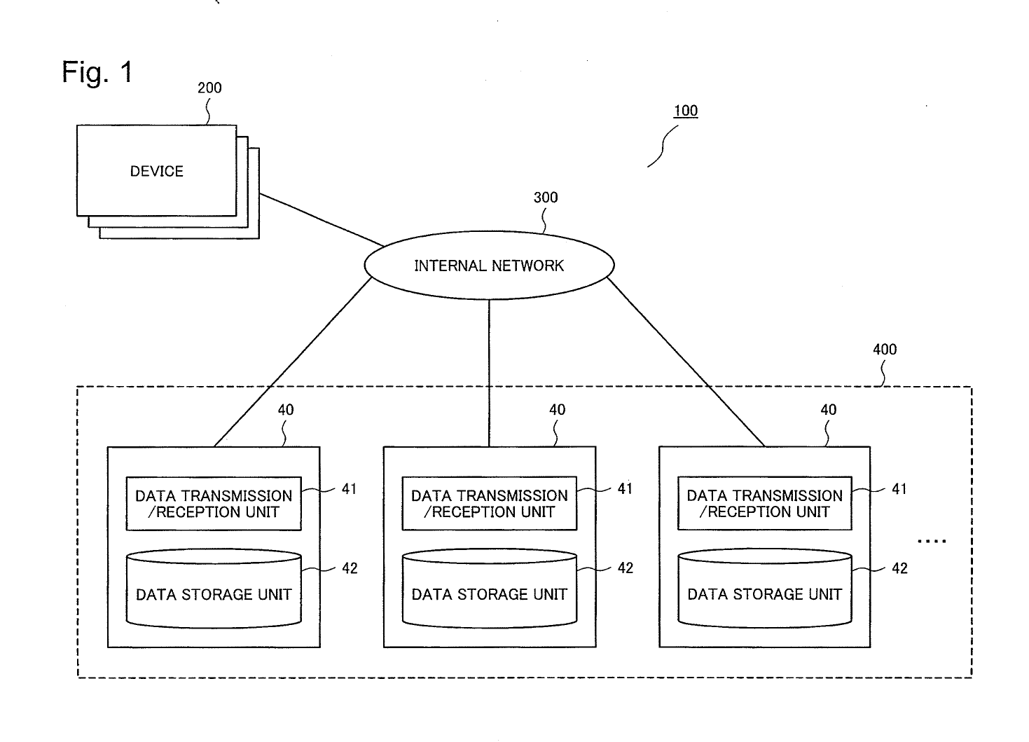

FIG. 1 is a block diagram illustrating a configuration of a distributed storage system 100 according to a first exemplary embodiment of the present invention. As illustrated in FIG. 1, the distributed storage system 100 includes a device 200 and a distributed storage device 400, which can communicate with each other through an internal network 300.

The device 200 is a device equipped with, for example, a GPS, an acceleration sensor, a camera, or the like, and acquires positional information, acceleration, image data, and the like and transmits them to the distributed storage device 400 through the internal network 300.

The internal network 300 is achieved by, for example, Ethernet (registered trademark), Fibre Channel, FCoE (Fibre Channel over Ethernet (registered trademark)), InfiniBand, QsNet, Myrinet, Ethernet, PCI Express, Thunderbolt, or a higher protocol, such as TCP/IP (Transmission Control Protocol/Internet Protocol) and RDMA (Remote Direct Memory Access) using them.

The distributed storage device 400 includes a plurality of storage nodes 40. The storage node 40 includes a data transmission/reception unit 41 that transmits/receives stream data through the internal network 300, and a data storage unit 42 that stores the received stream data.

Regarding the distributed storage device 400, the own device 400 does not necessarily receive stream data transmitted from the device 200, and a computer not illustrated in the drawing may receive the stream data and the distributed storage device 400 may receive the stream data from the computer.

The storage nodes 40 mutually transmit/receive the stream data through the internal network 300. The storage node 40 that accesses another storage node 40 is a client terminal. The client terminal may be a computer different from the own node, or a software instance (process, thread, fiber or the like) that operates on the computer. In addition, the client terminal may be the storage node 40, or a software instance that operates on another device configuring the distributed storage device 400. In addition, a plurality of pieces of software that operate on one or more computers may be virtually regarded as one client terminal.

According to the foregoing distributed storage device 400, the client terminal can acquire the stream data from each of the plurality of storage nodes 40 that distribute and accumulate the stream data transmitted from the device 200.

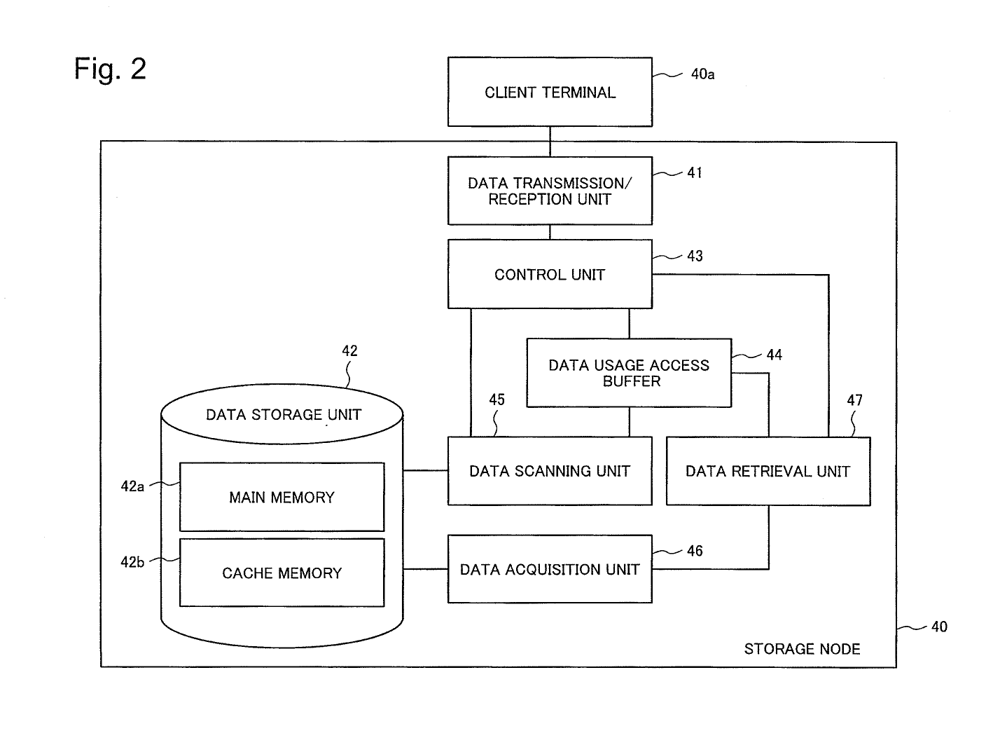

FIG. 2 is a block diagram illustrating a configuration of the storage node 40 according to the first exemplary embodiment of the present invention. As illustrated in FIG. 2, the storage node 40 includes the data transmission/reception unit 41, the data storage unit 42, a control unit 43, a data usage access buffer 44, a data scanning unit 45, a data acquisition unit 46, and a data retrieval unit 47. The data storage unit 42 includes a main memory 42a and a cache memory 42b.

The access request for data usage (read access) is referred to as “data usage access”, and an access request for data storage (write access) is referred to as “data storage access”. A terminal that transmits the data usage access or the data storage access to the storage node 40 is referred to as a client terminal 40a. When receiving an access request from the client terminal 40a, the storage node 40 performs processing in accordance with the request and sends a reply to the client terminal 40a.

Here, the storage node 40 may send the reply which includes whether the storage is success or failure to the data storage access. In addition, the storage node 40 may send the reply which includes whether data matching to the access-requested condition exists or not. In addition, in the case where the appropriate data exists, the storage node 40 may send the reply including a part or all of the data, or may send the reply including handle information necessary to acquire the data in place of a part or all of the data to the data usage access.

When handle information is included in the reply, the client terminal 40a can acquire data from the storage node 40, another storage node, or another information system using the handle information.

An outline of each component of the storage node 40 illustrated in FIG. 2 will be described. The data transmission/reception unit 41 transmits/receives stream data and an access request to/from the client terminal 40a. The data storage unit 42 stores the stream data received through the data transmission/reception unit 41.

The control unit 43 stores the stream data in the data storage unit 42 and stores the access request in the data usage access buffer 44, on the basis of the type of the access request received by the data transmission/reception unit 41.

The data usage access buffer 44 accumulates data usage accesses acquired from the control unit 43. The data scanning unit 45 scans the stream data stored in the data storage unit 42, on the basis of the data usage accesses stored in the data usage access buffer 44. The data acquisition unit 46 acquires the stream data scanned by the data scanning unit 45. The data retrieval unit 47 retrieves the data usage access buffer 44 to read a data usage access corresponding to the stream data acquired by the data acquisition unit 46.

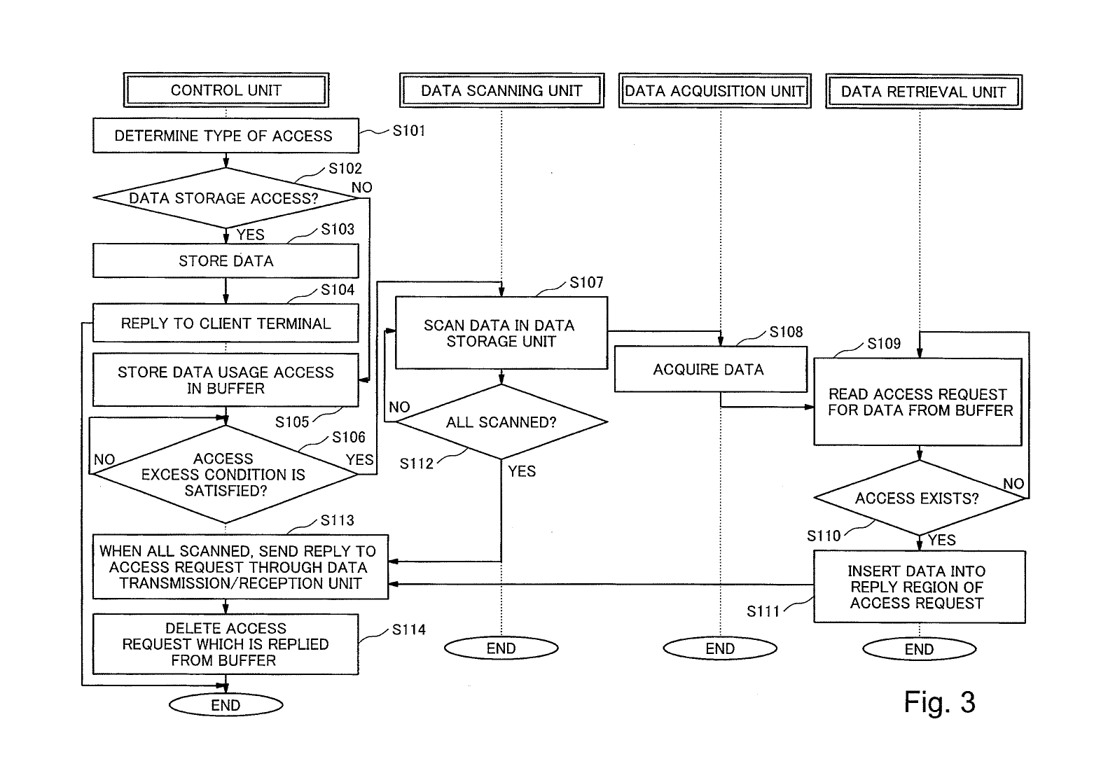

FIG. 3 is a flow chart describing an operation of the storage node 40. Details of the operation of the storage node 40 will be described with reference to FIG. 3.

When receiving an access request from the client terminal 40a, the data transmission/reception unit 41 notifies the access request to the control unit 43. The control unit 43 determines the type of the received access request (Step S101). When the access request is the data storage access (Step S102), the control unit 43 stores stream data (hereinafter, just referred to as “data”) acquired together with the data storage access in the data storage unit 42 (Step S103).

At this time, the control unit 43 may perform perpetuation processing of the stream data while physically storing the stream data in the data storage unit 42. More specifically, the control unit 43 may produce a replica of the stream data to store it, and may calculate an error-correcting code to add the error-correcting code to the stream data. In addition, the control unit 43 may change not only the stream data itself but also architecture data for managing data.

After storing the stream data, the control unit 43 sends an appropriate reply to the client terminal 40a (Step S104). The appropriate reply includes information indicating that the stream data is normally stored in the data storage unit 42. The reply may be sent before storing the data or may be sent after storing the data. When the reply before storing the data is permitted, the storage node 40 becomes a speedy configuration. When the reply after storing the data is permitted, the storage node 40 becomes a more failure-resistant configuration.

On the other hand, when the above-described access request is a data usage access, the control unit 43 stores the access request in the data usage access buffer 44 (Step S105).

The data usage access includes a data-specifying condition. The data-specifying condition is such a condition whether including or not including the key value of the stream data, the specific value of the part configuring the stream data or the range of the specific values.

For example, the data-specifying condition when the stream data is configured as {key: hogehoge, name1: value1, name2: value2} is “‘key’ is ‘hogehoge’”, “‘name1’ is between ‘value0’ and ‘value2’”, or the like. However, the data-specifying condition in the present invention described using the present exemplary embodiment of the present application as an example is not limited to the above.

The control unit 43 stores the received data usage accesses in the data usage access buffer 44 until a prescribed access trigger condition is satisfied (Step S106). Here, the access trigger condition may be, for example, the case where the number of the access requests stored in the data usage access buffer 44 is a given number or more. Alternatively, the access trigger condition may be the case where the amount of the access requests stored in the data usage access buffer 44 is a given amount or more. Alternatively, the access trigger condition may be the case where prescribed time has passed since issuance time of the oldest data usage access stored in the data usage access buffer 44. Alternatively, the access trigger condition may be the case where the above-described examples are combined. However, the access trigger condition in the present invention described using the present exemplary embodiment of the present application as an example is not limited to the above.

When the prescribed access trigger condition is satisfied, the control unit 43 instructs the data scanning unit 45 to scan the stream data. In response to the above-described instruction, the data scanning unit 45 sequentially scans the data stored in the data storage unit 42 by reference to the access requests stored in the data usage access buffer 44 (Step S107). The scanning order is preferably a system capable of accessing faster from the data storage unit 42.

Specifically, the scan means that the data stored in the main memory 42a is read and written in the cache memory 42b, and, in the cache memory 42b, the written data is specified in order.

For example, the data scanning unit 45 may scan all of the data in order of memory addresses of the main memory 42a of the data storage unit 42. Alternatively, the data scanning unit 45 may scan data stored in the cache memory 42b first, and then, scan unscanned data (details will be described below).

As data to be scanned, all of preset necessary data stored in the data storage unit 42 is targeted. The necessary data is, for example, all of the stored data, data updated after scanning previous time among the stored data, data updated in the latest one second among the stored data, or the like.

As described above, the data scanning unit 45 sends the specified data to the data acquisition unit 46 in order (Step S108). Here, the data scanning unit 45 may send all of the specified data or only a part of the data required for data access to the data acquisition unit 46.

The above-described data is sent from the data acquisition unit 46 to the data retrieval unit 47. When receiving the data, the data retrieval unit 47 reads an access request (data usage access) for the data from the data usage access buffer 44 (Step S109). When the access request for the data exists (Step S110), the data retrieval unit 47 inserts the data acquired from the data acquisition unit 46, a part of the data, or handle information for specifying the data into a reply region of the access request (Step S111).

For example, it is assumed that the data-specifying condition which is included in the access request “X” stored in the data usage access buffer 44 is “‘key’ is ‘hogehoge’”. In this case, the data “P” whose “key=hogehoge” is specified by the data scanning unit 45, and the data retrieval unit 47 that has acquired the data “P” stores the data “P” in a reply region of the access request “X”.

In addition, for example, the data-specifying condition included in the access request “Y” stored in the data usage access buffer 44 is assumed to be “‘name1’ of data that is ‘key’ is ‘hogehoge’”. In this case, the data “P” that is “key=hogehoge” is specified by the data scanning unit 45, and the data retrieval unit 47 that has acquired the data “P” stores “name1” of the data P in a reply region of the access request “Y”.

The data retrieval unit 47 sends the access request in which the data is inserted into its reply region to the control unit 43. When receiving a notice indicating that all of the required data has been scanned from the data scanning unit 45 (Step S112), the control unit 43 sends the a reply to the access request to the client terminal 40a through the data transmission/reception unit 41, on the basis of the information stored in the data usage access buffer 44 (Step S113). Then, the control unit 43 deletes the replied access request from the data usage access buffer 44 (Step S114).

According to the above-described operation, the storage node 40 accumulates the data usage accesses in the data usage access buffer 44, and when the access trigger condition is satisfied, scans the data stored in the data storage unit 42 in order. According to this operation, the storage node 40 can send the appropriate data when receiving a data usage access from another terminal.

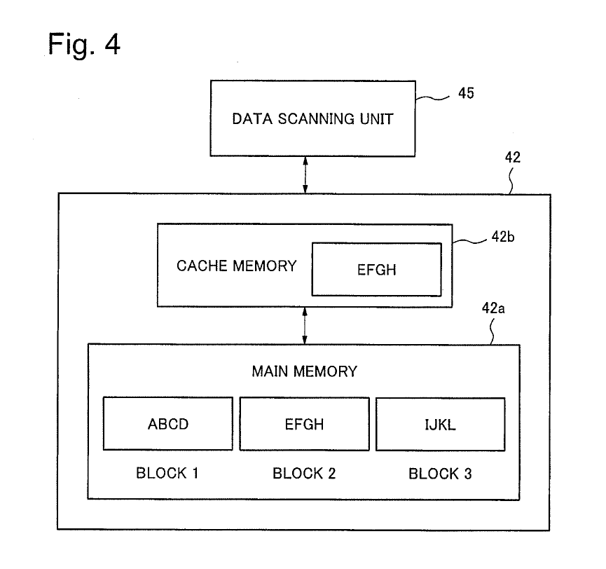

Here, a cache hit ratio when scanning the data storage unit 42 as described above will be described. For example, as illustrated in FIG. 4, data “A”-“L” is stored in the main memory 42a in the data storage unit 42 and data “E”-“H” is stored in the cache memory 42b in the data storage unit 42. The data is stored in each block, and a cache size is one block.

For example, the case where, when the data usage access is sent in order to the data “C”, “G”, “L”, and “D” and they are accumulated in the data usage access buffer 44, the access trigger condition is satisfied (YES at Step S106 of FIG. 3) will be described. The data scanning unit 45 scans all of the data in order of memory addresses of the main memory 42a in the data storage unit 42. More specifically, firstly, the data scanning unit 45 reads block 1 of the main memory 42a and writes block 1 in the cache memory 42b, and scans the cache memory 42b (this scan is referred to as “first scan”). As a result of the first scan, the data “A”, “B”, “C”, and “D” is specified. Next, the data scanning unit 45 reads block 2 of the main memory 42a and writes block 2 in the cache memory 42b, and scans the cache memory 42b (this scan is referred to as “second scan”). As a result of the second scan, the data “E”, “F”, “G”, and “H” is specified. Next, the data scanning unit 45 reads block 3 of the main memory 42a and writes block 3 in the cache memory 42b, and scans the cache memory 42b (this scan is referred to as “third scan”). As a result of the third scan, the data “I”, “J”, “K”, and “L” is specified.

In the first scan, access for the data A is missed (cache miss). On the other hand, block 1 is stored in the cache memory 42b, and thus, “B”, “C”, and “D” from the data of block 1 can be read from the cache memory 42b (cache hit). Similarly, in the second scan, while access for the data E is cache-missed, block 2 is stored in the cache memory 42b, and thus, “F”, “G”, and “H” from the data of block 2 are cache-hit. Similarly, in the third scan, while access for the data I is cache-missed, block 3 is stored in the cache memory 42b, and thus, “J”, “K”, and “L” from the data of block 3 are cache-hit.

More specifically, the result of the above-described cache miss/cache hit for the data usage access is A(miss)B(hit)C(hit)D(hit)E(miss)F(hit)G(hit)H(hit)I(miss)J(hit)K(hit)L(hit). Here, A(miss) means that the access for the data A is missed (cache miss), and B(hit) means that the data B can be read from the cache memory 42b (cache hit). Among all of the data scanned in this manner, the data C, G, L, and D would be a target of the above-described access request. In this example, the cache miss occurs three times.

On the other hand, it is assumed that the data scanning unit 45 does not scan all of the data of the main memory 42a but accesses the data C, G, L, and D with every reception of the access request. In this case, the result of the access is C(miss)G(miss)L(miss)D(miss) in the case of the example illustrated in FIG. 4. More specifically, the cache miss occurs four times in this case.

In this manner, for example, in the case of processing N-times data usage accesses, N times cache misses and N times TLB misses occur in the worst case by the conventional technique. On the other hand, in the present first exemplary embodiment, when the cache memory 42b in the data storage unit 42 can store 100(one hundred) objects in one page, the data can be acquired with “N/100” times cache misses in the worst case, and thus, the cache hit ratio can be improved.

As described above, according to the present first exemplary embodiment, the control unit 43 accumulates the received access requests in the data usage access buffer 44. When the access trigger condition is satisfied, the data scanning unit 45 scans all of the data of the data storage unit 42 in order. The data retrieval unit 47 reads an access request for the data which is specified by the scan from the data usage access buffer 44. The control unit 43 inserts information regarding the specified data into the read access request and sends the read access request to the client terminal 40a.

By this configuration, according to the present first exemplary embodiment, execution of the data usage access could be sequential with respect to the data storage unit 42, and the number of times of cache misses and TLB misses with respect to the number of accesses per hour can be reduced. Therefore, during in-memory storage access in small access locality environment, the effect that data can be provided with higher throughput performance can be obtained.

### Second Exemplary Embodiment

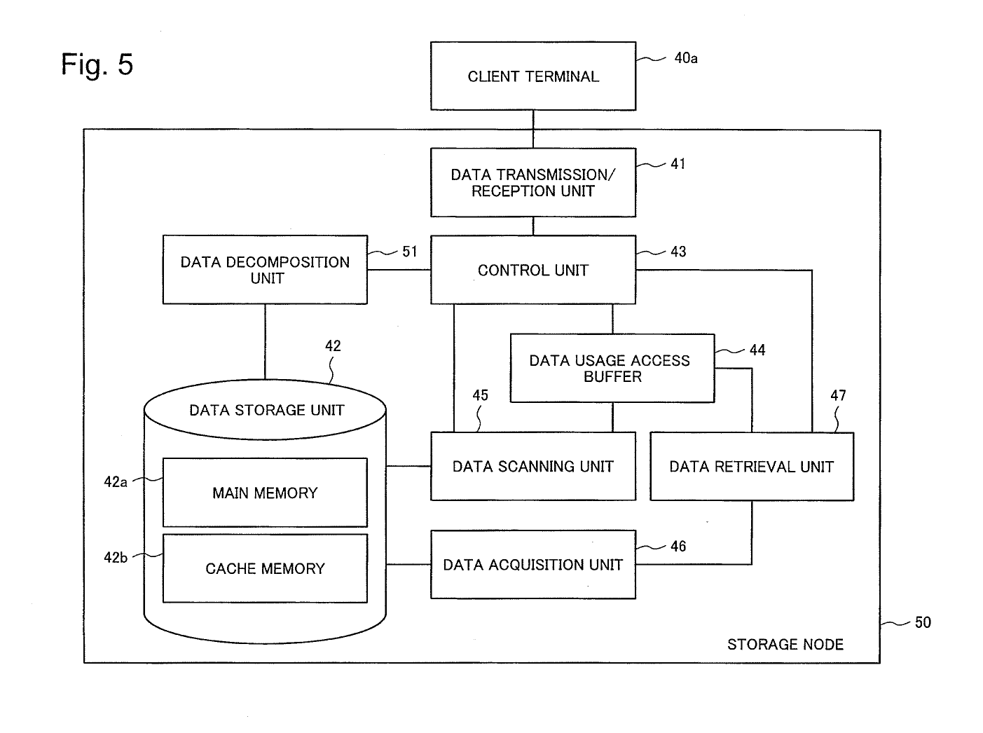

FIG. 5 is a block diagram illustrating a configuration of a storage node 50 according to a second exemplary embodiment of the present invention. As illustrated in FIG. 5, the storage node 50 includes a data decomposition unit 51 in addition to the storage node 40 according to the first exemplary embodiment.

The data decomposition unit 51 decomposes stream data sent from the control unit 43 into a plurality of fragments, and stores the fragments in the data storage unit 42 in a decomposition manner.

As an example of a technique of the data decomposition unit 51 to store data in the data storage unit 42, a technique called a column-oriented format is conceivable.

For example, in the case where the data decomposition unit 51 stores three pieces of data, i.e.
{key: “key1”, uid: “101”, temp: 3},
{key: “key2”, uid: “102”, temp: 10}, and
{key: “key3”, uid: “103”, temp: 11}
   in the column-oriented format, the data decomposition unit 51 stores the respective pieces of data in the decomposition manner as follows. That is, the data decomposition unit 51 stores the respective pieces of data as follows:
memory-area1{“key1”, “key2”, “key3”, . . . },
memory-area2{“101”, “102”, “103”, . . . }, and
memory-area3{3, 10, 1, . . . }.
   Here, the above-described storage format is an example, and the storage format in the present invention described using the present exemplary embodiment of the present application as an example is not limited to the above.

When data is stored as described above, for example, in the case where the access only to “uid” values with respect to all of the data is requested, it can be accessed without “key” values, “temp” values, or the like being written in a memory or a CPU register. Accordingly, it is known that fast access is possible. On the other hand, storing the data in the column-oriented format, the content of the same property of other data is also read even though it is not required. Thus, storing data in the column-oriented format also has an inefficient aspect.

Accordingly, the storage node 50 according to the second exemplary embodiment of the present invention stores data more efficiently, and thus increases the speed of the access for data use.

More specifically, the data decomposition unit 51 stores the data acquired from the control unit 43 in the data storage unit 42 in the column-oriented format. The data scanning unit 45 scans only the property part included in the data-specifying condition among the data stored in the data storage unit 42. Other components operate in the same manner as the operation described in the first exemplary embodiment, and thus, the description thereof is omitted.

In this manner, in the present second exemplary embodiment, the data decomposition unit 51 stores the data in the data storage unit 42 in the decomposition manner, and the data scanning unit 45 scans only the property part included in the data-specifying condition. Accordingly, the number of times of cache misses with respect to the number of accesses per hour can be further reduced.

For example, in the case of processing N-times data usage accesses, in the configuration described in the first exemplary embodiment, “N/100” times cache misses and N times TLB misses occur in the worst case. On the other hand, according to the present second exemplary embodiment, for example, when the capacity of the access target property is 10% of the capacity of the entire data object, the data can be acquired with “N/1000” times cache misses and TLB misses in the worst case.

As described above, according to the second exemplary embodiment, the data decomposition unit 51 stores the data acquired from the control unit 43 in the data storage unit 42 in the column-oriented format decomposition manner, for example. The data scanning unit 45 scans only the property part included in the data-specifying condition among the data stored in the data storage unit 42. By this configuration, the effect that the number of times of cache misses and TLB misses with respect to the number of accesses per hour can be further reduced can be obtained.

### Third Exemplary Embodiment

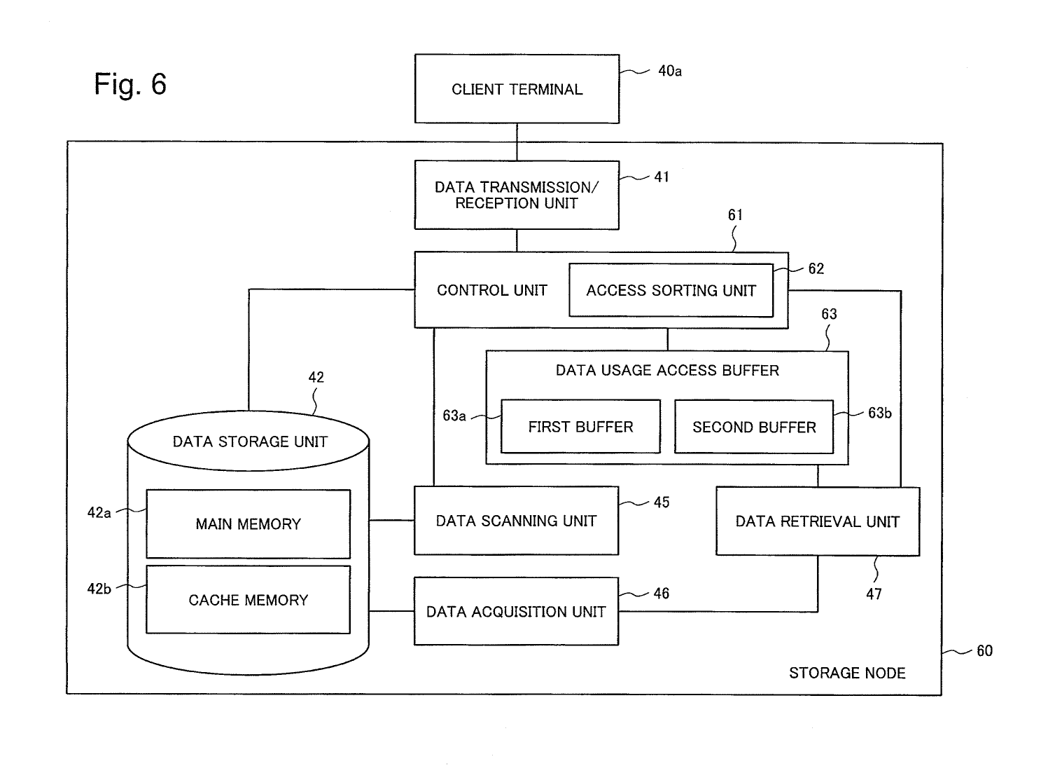

FIG. 6 is a block diagram illustrating a configuration of a storage node 60 according to a third exemplary embodiment of the present invention. As illustrated in FIG. 6, compared to the storage node 40 according to the first exemplary embodiment, the storage node 60 is different in configurations in which a control unit 61 includes an access sorting unit 62 and a data usage access buffer 63 includes a first buffer 63a and a second buffer 63b. Other configurations are the same as those of the storage node 40 according to the first exemplary embodiment.

The control unit 61 receives an access request from the data transmission/reception unit 41. When determining that the access request is the data usage access, the control unit 61 sorts the access request in accordance with an access buffer condition in the access sorting unit 62. The access sorting unit 62 stores the access request in one or both of the first buffer 63a and the second buffer 63b in accordance with the sorting.

The access buffer condition is a condition, for example, for sorting the access request with respect to each property which is used by the data usage access for specifying data. For example, the access buffer condition is a condition in which the data-specifying condition for the data {key: hogehoge, name1: value1, name2: value2} stores the access request that targets “key” in the first buffer 63a and the access request that targets “name1” in the second buffer 63b.

In this case, in reading of the access request from the buffer at S109 of FIG. 3, the data retrieval unit 47 uses the “key” part of the data for retrieving the first buffer 63a and the “name1” part of the data for retrieving the second buffer 63b.

More specifically, the data retrieval unit 47 decomposes the specified data received from the data acquisition unit 46, on the basis of the access buffer condition as needed (in this case, decomposes the data into the “key” part and the “name1” part), and uses the “key” part of the data for retrieving the first buffer 63a and the “name1” part of the data for retrieving the second buffer 63b.

In addition, as described in the second exemplary embodiment, the storage node 60 may include the data decomposition unit 51 and the data storage unit 42 may store the data in the decomposition manner. In this case, the data scanning unit 45 concurrently scans a region storing the “key” part and a region storing the “name” part of the data storage unit 42. The data retrieval unit 47 uses the “key” part of the data for retrieving the first buffer 63a and the “name1” part of the data for retrieving the second buffer 63b, with respect to the specified data received from the data scanning unit 45. By adopting the foregoing configuration, the storage node 60 is further increased in speed.

Furthermore, as another example of the access buffer condition, a condition for sorting the access request in accordance with a range of values of a part of the data is applicable. For example, the data-specifying condition for the data {key: hogehoge, name1: value1, name2: value2} stores the access request that targets data with “a” as initial of “key” in the first buffer 63a and the access request that targets data with “b” as initial of “key” in the second buffer 63b.

As described above, according to the third exemplary embodiment, the access sorting unit 62 sorts the access request in accordance with the access buffer condition, and stores the access request in one or both of the first buffer 63a and the second buffer 63b. The data retrieval unit 47 retrieves the access for the data received from the data acquisition unit 46 concurrently in the first buffer 63a and in the second buffer 63b on the basis of the access buffer condition. By adopting the foregoing configuration, the data usage access buffer 63 can be used efficiently, and thus, the effect that the storage node 60 is further increased in speed can be obtained.

In addition, when the storage node 60 has a plurality of multicore processors and each core holds a unique cache memory, a plurality of access buffer means may be arranged in caches of the different cores, respectively. By this configuration, the cache usage efficiency can be further improved, and system throughput can be improved.

### Fourth Exemplary Embodiment

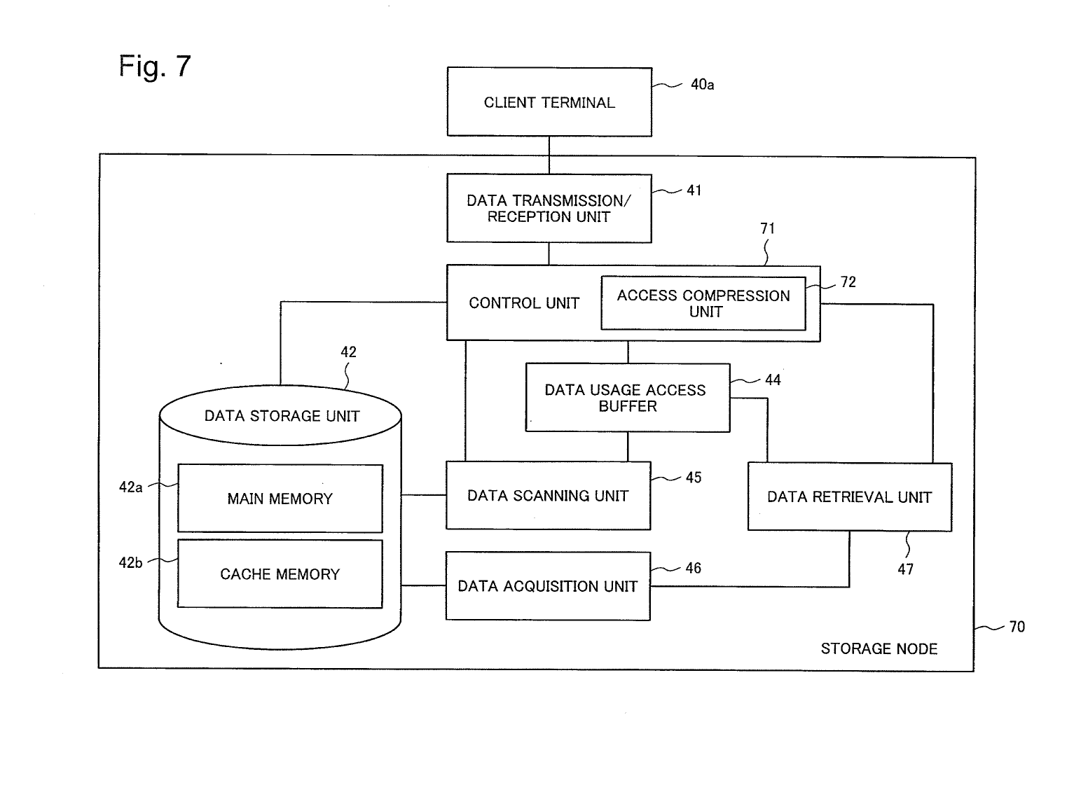

FIG. 7 is a block diagram illustrating a configuration of a storage node 70 according to a fourth exemplary embodiment of the present invention. As illustrated in FIG. 7, compared to the storage node 40 according to the first exemplary embodiment, the storage node 70 is different in configuration in which a control unit 71 includes an access compression unit 72, and other configurations are the same as those of the storage node 40 according to the first exemplary embodiment.

The control unit 71 receives the access request from the data transmission/reception unit 41. When determining that the access request is the data usage access, the control unit 71 compresses data in the access compression unit 72. More specifically, the access compression unit 72 extracts minimum information capable of specifying the data (access-specifying information) from the data usage access. For example, the access compression unit 72 extracts a pair of a several-bit data access identifier and a several-bit data-specifying condition. Accordingly, the storage node 70 can execute a single access, on the basis of about two-byte information.

The access compression unit 72 stores the access-specifying information and information indicating the entire access in different regions in the data usage access buffer 44. At Step S109 of FIG. 3, the data retrieval unit 47 retrieves only the access-specifying information stored in the data usage access buffer 44 to read the access request corresponding to the specified data.

As described above, according to the fourth exemplary embodiment, the access compression unit 72 extracts the access-specifying information from the data usage access, and stores the access-specifying information in the data usage access buffer 44. The data retrieval unit 47 retrieves the access-specifying information from the data usage access buffer 44 to read the access request corresponding to the specified data. By this configuration, the data retrieval unit 47 retrieves only the region of the data usage access buffer 44 which stores the access-specifying information, and thus, the effect that the data usage access can be further increased in speed can be obtained.

### Fifth Exemplary Embodiment

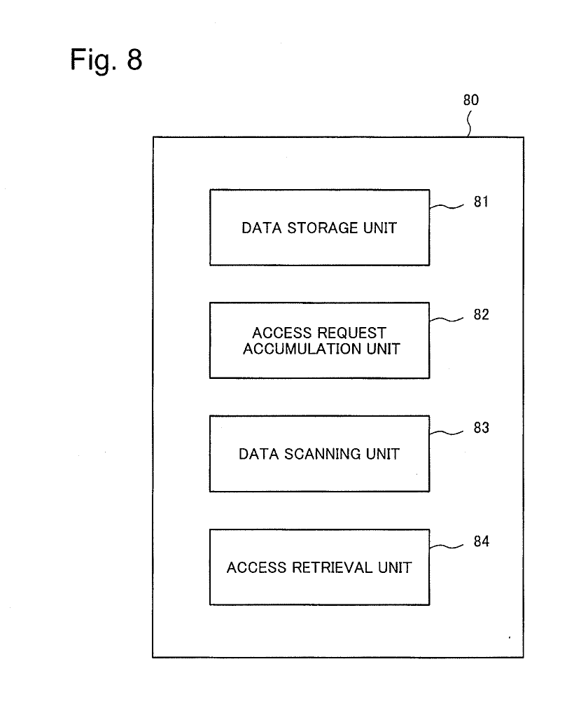

FIG. 8 is a block diagram illustrating a configuration of a storage node 80 according to a fifth exemplary embodiment of the present invention. As illustrated in FIG. 8, the storage node 80 includes a data storage unit 81, an access request accumulation unit (data usage access buffer) 82, a data scanning unit 83, and an access retrieval unit 84.

The data storage unit 81 has a main memory that stores data in a block unit, and a cache memory capable of storing the data stored in the main memory in the block unit.

The access request accumulation unit 82 accumulates access requests for data stored in the data storage unit 81. When the access request accumulated in the access request accumulation unit 82 satisfy a prescribed condition, the data scanning unit 83 reads the data stored in the main memory included in the data storage unit 81 in order in the block unit, and writes the data in the cache memory and scans the data.

The access retrieval unit 84 reads from the access request accumulation unit 82 an access request for data specified by the scan, and replies information with which the specified data can be specified to a source from with the access request was transmitted.

By the above-described configuration, according to the present fifth exemplary embodiment, during in-memory storage access in an access environment with little locality, the effect that data can be provided with higher throughput performance can be obtained.

The above-described respective exemplary embodiments can be implemented by being arbitrarily combined. In addition, the invention of the present application can be implemented in various forms without limiting to the above-described respective exemplary embodiments.

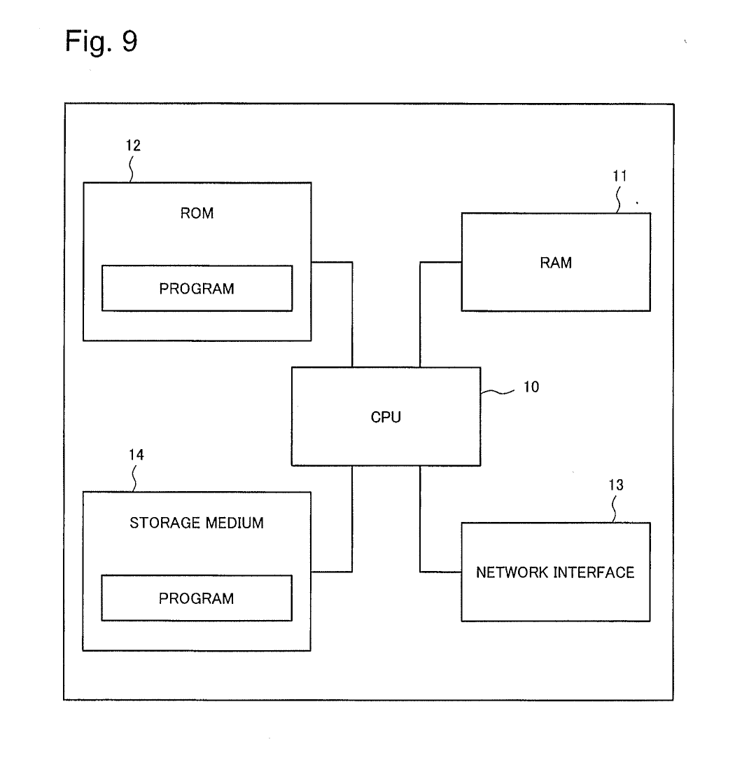

In addition, the respective components of the storage nodes (storage devices) illustrated in FIG. 2, FIG. 5, FIG. 6, FIG. 7, and FIG. 8 are achieved by hardware resources illustrated in FIG. 9, in the case of being achieved by a computer. More specifically, a configuration illustrated in FIG. 9 includes a CPU 10, a RAM (Random Access Memory) 11, a ROM (Read Only Memory) 12, a network interface 13, and a storage medium 14. The CPU 10 of the storage node reads various software programs (computer programs) stored in the ROM 12 or the storage medium 14, and writes the software programs in the RAM 11 and executes the software programs to manage the entire operation of the storage node. More specifically, in the above-described respective exemplary embodiments, the CPU 10 executes the software programs that execute respective functions (respective components) included in the storage node while arbitrarily referring to the ROM 12 or the storage medium 14.

In addition, in the above-described respective exemplary embodiments, as an example in which the CPU 10 illustrated in FIG. 9 executes the storage nodes (storage devices) illustrated in FIG. 2, FIG. 5, FIG. 6, FIG. 7, and FIG. 8, the case of being achieved by a software program has been described. However, a part or all of functions illustrated in the respective blocks illustrated in the above-described respective drawings may be achieved as hardware.

A computer program capable of achieving functions of the flow chart (FIG. 3) referred in the description is supplied to the storage node (storage device), and then, the CPU 10 writes the computer program in the RAM 11 and executes the computer program, so that the present invention described using the respective exemplary embodiments as examples is achieved.

In addition, the foregoing supplied computer program may be stored in a computer-readable storage device, such as a readable and writable memory (temporary storage medium) or a hard disk device. In this case, it can be thought that the present invention is configured by a code representing the foregoing computer program or a recording medium storing the foregoing computer program.

Heretofore, the invention of the present application has been described with reference to the exemplary embodiments, but the invention of the present application is not limited to the above-described exemplary embodiments. With respect to the configuration and details of the invention of the present application, various changes which those skilled in the art can understand may be made within the scope of the invention of the present application.

This application claims priority to Japanese Patent Application No. 2013-157346 filed on Jul. 30, 2013, the entire contents of which are incorporated herein.

### INDUSTRIAL APPLICABILITY

The present invention can be applied to, for example, a system for storing and processing sensor information of a cell-phone or a smartphone, and a system for storing and processing log information of a computer system. In addition, the present invention can be applied to, for example, a system for storing and processing electric power production information and usage information, such as smart grid and digital grid, and a system for storing and processing vehicle sensor and vehicle navigation system information, such as ITS (Intelligent Transport Systems). In addition, the present invention can be applied to, for example, a M2M (Machine To Machine) system for collecting buying information and operation information of a machine, such as a vending machine, by a sequential network.

### REFERENCE SIGNS LIST

40 STORAGE NODE
41 DATA TRANSMISSION/RECEPTION UNIT
42 DATA STORAGE UNIT
43 CONTROL UNIT
44 DATA USAGE ACCESS BUFFER
45 DATA SCANNING UNIT
46 DATA ACQUISITION UNIT
47 DATA RETRIEVAL UNIT
51 DATA DECOMPOSITION UNIT
62 ACCESS SORTING UNIT
72 ACCESS COMPRESSION UNIT

1. A storage device comprising:
a data storage unit which has a main memory that stores data in a block unit, and a cache memory capable of storing the data stored in the main memory in the block unit;
an access request accumulation unit which accumulates an access request for data stored in the data storage unit;
a data scanning unit, when the access request accumulated in the access request accumulation unit satisfy a prescribed condition, reads the data stored in the main memory included in the data storage unit in order in the block unit, and writes the data in the cache memory and scans the data; and
an access retrieval unit which reads from the access request accumulation unit an access request for data specified by the scan, and replies information with which the specified data can be specified to a source from with the access request was transmitted.

2. The storage device according to claim 1, wherein
the data scanning unit reads the data in order of memory addresses of the main memory by the block units, and writes the data in the cache memory.

3. The storage device according to claim 1, wherein,
when data is stored in the cache memory, the data scanning unit scans the data, and then, reads unscanned data in the order by the block units from the main memory, and writes the unscanned data in the cache memory.

4. The storage device according to claim 1, further comprising:
a data decomposition unit which decomposes data including a key value and a property associated with the key value into the key value and the property, and stores the data in the data storage unit in a decomposition manner, wherein
the data scanning unit writes the property of the data stored in the main memory included in the data storage unit in the cache memory, and scans the property.

5. The storage device according to claim 1, further comprising:
an access sorting unit which accumulates the access requests in different regions of the access request accumulation unit with respect to each target for specifying the data, wherein
the access retrieval unit reads the access request for specified data by the scan from the region in which the access request including the target for specifying the data is accumulated.

6. The storage device according to claim 1, further comprising:
an access compression unit which extracts information capable of specifying the data from the access requests, and accumulates the extracted information and the access requests in different regions of the access request accumulation unit, wherein
the access retrieval unit reads the access request for specified data by the scan from the region in which the information capable of specifying the data is accumulated.

7. The storage device according to claim 1, wherein
the data scanning unit reads all of the data in an order of memory addresses of the main memory in the block units, and writes the all of the data in the cache memory.

8. A data access method comprising:
accumulating an access request for data stored in a data storage unit which includes a main memory that stores data in a block unit, and a cache memory capable of storing the data stored in the main memory in the block unit, in an access request accumulation unit;
when the access request accumulated in the access request accumulation unit satisfy a prescribed condition, reading the data stored in the main memory included in the data storage unit in order in the block unit, and writing the data in the cache memory and scanning the data by a data scanning unit; and
by an access retrieval unit, reading from the access request accumulation unit an access request for data specified by the scanning, and replying information with which the specified data can be specified to a source from with the access request was transmitted.

9. The data access method according to claim 8, wherein,
in the scanning, the data is written in the cache memory in an order of memory addresses of the main memory in the block unit.

10. A program recording medium recording a data access program which makes a computer execute:
processing of accumulating an access request for data stored in a data storage unit which includes a main memory that stores data in a block unit, and a cache memory capable of storing the data stored in the main memory in the block unit, in an access request accumulation unit;
processing of, when the access request accumulated in the access request accumulation unit satisfy a prescribed condition, reading the data stored in the main memory included in the data storage unit in order in the block unit, and writing the data in the cache memory and scanning the data; and
processing of reading from the access request accumulation unit an access request for data specified by the scanning, and replying information with which the specified data can be specified to a source from with the access request was transmitted.
